(19) United States
(12) Patent Application Publication
(10) Pub. No.: US 2005/0225534 A1
(43) Pub. Date: Oct. 13, 2005

(54) Program execution system by simultaneoous click of double buttons of mouse and execution method of the same

(76) Inventor: Won-Hyuk Chang, Seoul (KR)

Correspondence Address: PARK & SUTTON LLP, 3255 WILSHIRE BLVD, SUITE 1110, LOS ANGELES, CA, 90010, US

(21) Appl. No.: 10/923,760

(22) Filed: Aug. 23, 2004

(30) Foreign Application Priority Data
Apr. 9, 2004 (KR) 24572/2004

(51) Int. Cl. G09G 5/08; G09G 5/00

(52) U.S. Cl. 345/163; 345/172

(57) ABSTRACT

The present invention relates to a program execution system by a simultaneous click of double buttons of a mouse, and an execution method of the same capable of first executing a certain program irrespective of an ongoing program by simultaneously clicking left and right buttons of a computer mouse.

### CLAIMING FOREIGN PRIORITY

The applicant claims and requests a foreign priority, through the Paris Convention for the Protection of Industry Property, based on a patent application filed in the Republic of Korea (South Korea) with the filing date of Apr. 9, 2004, with the patent application number 10-2004-0024572, by the applicant. (See the attached Declaration)

### BACKGROUND OF THE INVENTION

The present invention relates to a program execution system by a simultaneous click of double buttons of a mouse, and an execution method of the same capable of first executing a certain program irrespective of an ongoing program by simultaneously clicking the left and right buttons of a computer mouse.

### BACKGROUND ART

Recently, a personal computer has been sharply supplied to home. The PC is connected with the Internet and becomes an important utility in our life.

The computer includes various programs such as a document writing program, an edit program, an internet-related program, etc. A user selects an execution file of a desired program and executes the same.

FIG. 1 is a view illustrating a selection screen of a program used when executing a conventional program. As shown therein, in order to execute a desired program in a computer, a start menu 1 of a work display line is clicked, and then an execution file 2 provided in the start menu is selected, so that a corresponding program is executed. In another way, an execution file of a corresponding program is copied on a background screen and is double-clicked for thereby executing the program.

However, the method for executing the execution file using the start menu 1 has the problems that the user clicks the start menu 1 while doing other programs, and then the user selects the execution file 2 again, so that the complicated works are performed. In addition, the method for selecting and executing a program on the background screen has the problems that when other programs are undergone, the screen that a corresponding program is displaced should be changed to the background screen, and then the program should be selected, thus causing much inconvenience.

In addition, in order to connect with a certain internet site, the internet browser program is clicked, and the clicked program is displayed on the screen. Thereafter, the uniform resource locator (domain name) of a corresponding internet site is inputted into an address input section for thereby connecting to a desired internet site. In this case, the internet connection steps are increased.

In order to overcome the above problems, the applicant of the present invention who filed the patent of Korean patent registration No. 0417639 (Internet site connection method) has disclosed a method in which it is possible to directly connect to a certain internet site by a double click of a mouse while using the program. However, the above internet site connection method has the problems that it is possible to easily connect to the internet, but the conventional method should be used for executing the program internally installed in the computer.

### DISCLOSURE OF INVENTION

Accordingly, it is an object of the present invention to provide a program execution system using a simultaneous click of double buttons of a mouse and an execution method of the same capable of fast executing a certain program irrespective of an ongoing program when the left and right buttons of a computer mouse are simultaneously clicked.

To achieve the above objects, there is provided a program execution method using a simultaneous click of double buttons of a mouse, comprising a step in which when the double buttons of a mouse are clicked, an execution file of a program to be executed is registered; a step in which when a button of a mouse is clicked, it is judged whether the click corresponds to a click using the double buttons of the mouse; a step in which when it is confirmed that the double buttons are clicked, a cancellation signal is transferred to the computer operating system for canceling a display of the menu window set when the mouse of the computer clicks; a step in which the list with respect to the registered program is displayed; and a step in which the execution file of the program selected from the list is executed.

The execution file is one selected from programs such as Hangeul, word, photoshop, internet explorer, game, etc., individual file installed in computer, URL of the internet site, RSS (Really Simple Syndication page, news page, internet service, etc.

In the case that the execution file registered in the management program is one, the registered execution file is directly executed when the simultaneous click of the double buttons of the mouse is confirmed.

To achieve the above objects, there is provided a program execution system by a simultaneous click using double buttons of a mouse, comprising an execution file registration module in which information concerning an execution file of a program executed when the double buttons of a mouse are simultaneously clicked through a management program is registered, and the information is stored in an execution file DB and is managed; a mouse click recognition module that recognizes a left button click, a right button click, and a simultaneous click of left and right buttons of a mouse connected with the computer; an operating system (OS) management module that transfers a menu window cancellation signal to the computer OS so that a set menu window is not displayed when the button of a mouse of a computer is clicked at the time when the double buttons of the mouse of the computer are simultaneously clicked; a registration file execution module that executes the selected program when a user selects a corresponding program from the lists of the execution files displayed together with the management program when the simultaneous click of the double buttons of the mouse is recognized by the mouse click recognition module; and a control module that controls a data flow of each module.

### BRIEF DESCRIPTION OF DRAWINGS

The present invention will become better understood with reference to the accompanying drawings which are given only by way of illustration and thus are not limitative of the present invention, wherein;

FIG. 1 is a view of a selection screen of a program used when a conventional program is executed;

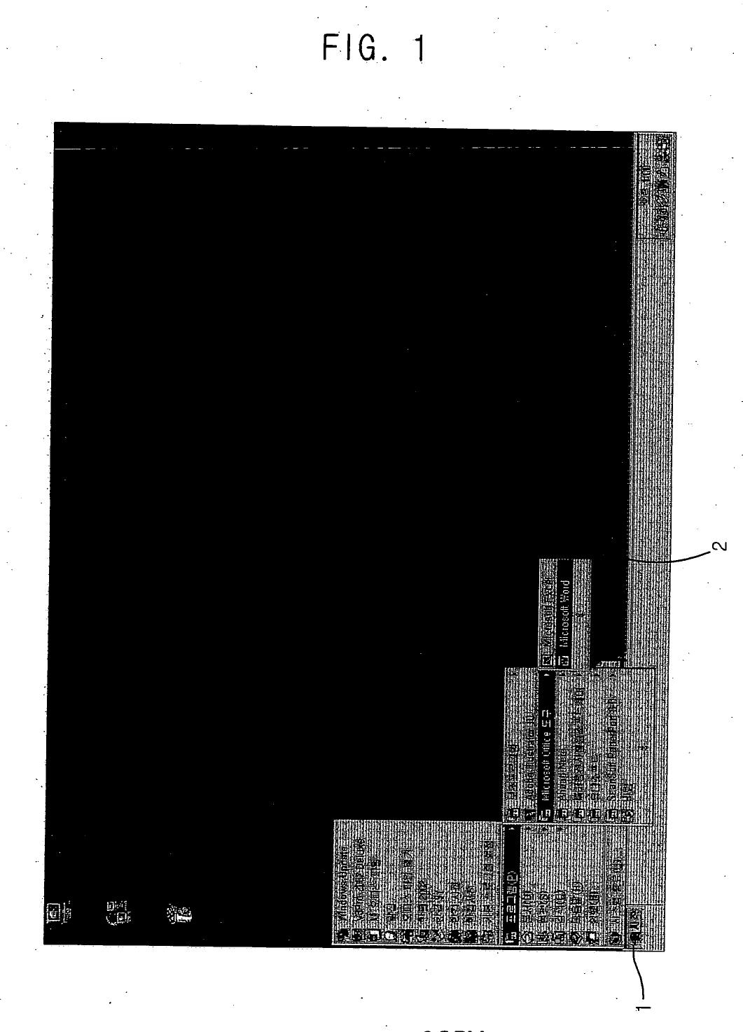

FIG. 2 is a view of a management program based on a program execution system by a simultaneous click of double buttons of a mouse according to the present invention;

FIG. 3 is a block diagram of a program execution system by a simultaneous click of double buttons of a mouse according to the present invention;

FIG. 4 is a flow chart of a program execution method by a simultaneous click of double buttons of a mouse according to the present invention; and

FIG. 5 is a view of a screen displaced according to the present invention.

### BEST MODE FOR CARRYING OUT THE INVENTION

The program execution system using a simultaneous click of double buttons of a computer mouse according to the present invention will be described with reference to the accompanying drawings.

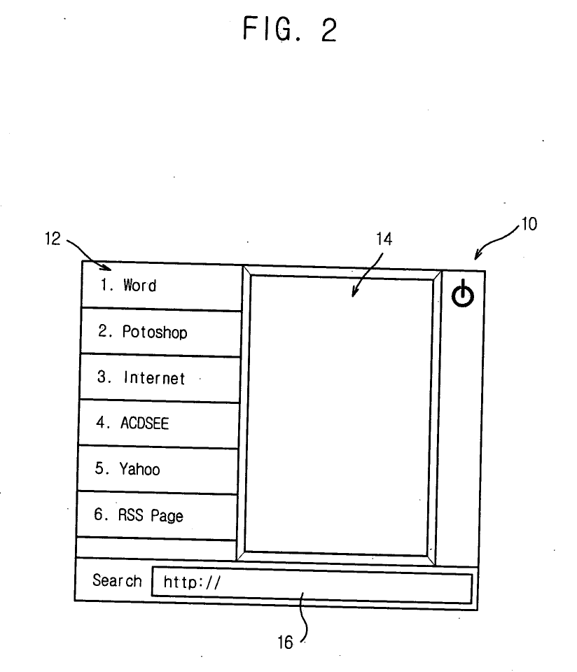

As shown in FIG. 2, when performing various works on a computer, when a user simultaneously clicks the left and right buttons of the mouse, the management program 10 is executed, and when a desired program is selected from the lists registered in the management program 10, an execution file of a corresponding program is executed.

Here, the management program 10 includes an execution file management window 12 in which the list of execution files is displayed, and a user can input, an address input window 16 in which a user can input an address of a desired internet site, and a display screen 14 in which an internet screen inputted through the address input window is received and displayed. For example, the display screen 14 of the management program may be used as a browser for receiving various internet contents such as a real time download service of a motion picture or a music file or a real time news service.

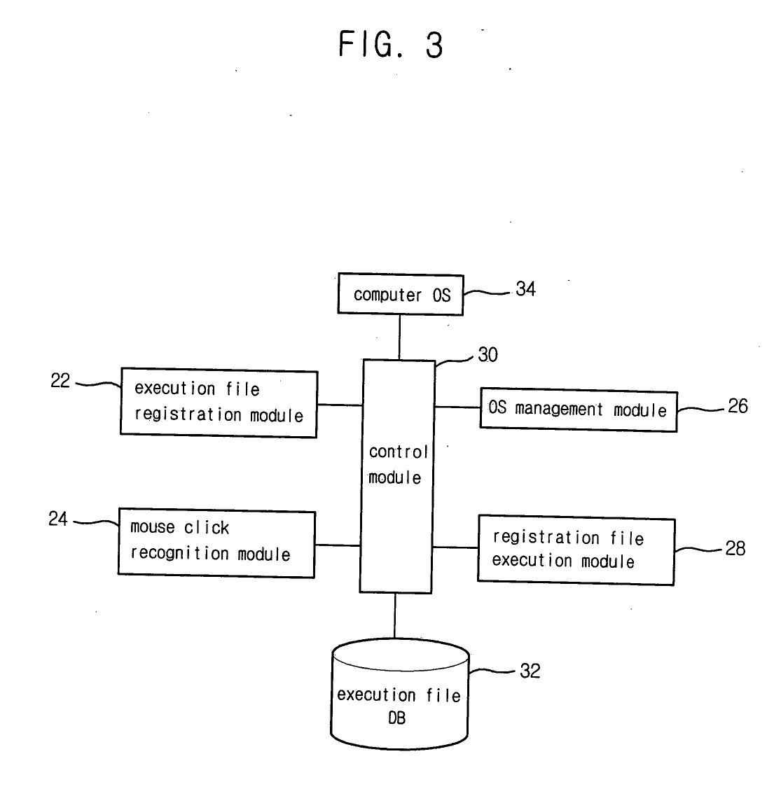

As shown in FIG. 3, the program execution system using a simultaneous click of double buttons of a mouse according to the present invention will be described. Here, the program execution system includes an execution file registration module 22, a mouse click recognition module 24, an OS management module 26, a registration file execution module 28, and a control module 30. A database such as an execution file DB 32, etc. is further provided.

Here, the execution file registration module 22 receives information with respect to an execution file of a program executed when double buttons of a mouse are simultaneously performed through the management program 10 and stores into the execution file DB 32 and manages the same. In the kinds of the execution files executed, there are Hangeoul, word, photoshop, internet explorer, game programs, individual files installed in computer, URL of internet sites, RSS page, news page, etc. Here, the RSS (Really Simple Syndication) is a format in which the frequently updated sites can easily provide the users with the updated information and is made based on XML (Extensible Markup Language). It is possible to recognize at least information needed for distributions such as title, content, date, etc.

The mouse click recognition module 24 judges whether the click corresponds to the left button click, the right button click or the double button click in the case that the button of the mouse connected with the computer is clicked. At this time, when the double button clicks of the mouse are sequentially performed within a certain time period such as 0.1 seconds or 0.3 seconds, it is recognized as the double buttons of mouse are clicked at the same time. The above recognition time may be set with shorter time period.

The OS management module 26 transfers a menu window cancellation signal to the computer operating system (34: hereinafter referred to as OS) so that the set menu displayed when the button of the mouse is clicked is not displayed. Therefore, when the double button click of the mouse is recognized, the menu window is not displayed on the computer, and the management program 10 of the program execution file is displayed.

When the double button click of the mouse is recognized by the mouth click recognition module 24, and the user selects a certain program from the lists of the execution files, the registration file execution module 28 executes the selected program. The execution information with respect to the selected program is provided to the computer OS as if a corresponding program is executed. The registration file execution module 28 may be set so that the computer OS 34 executes a corresponding program.

In addition, the control module 30 controls the data flow of each module.

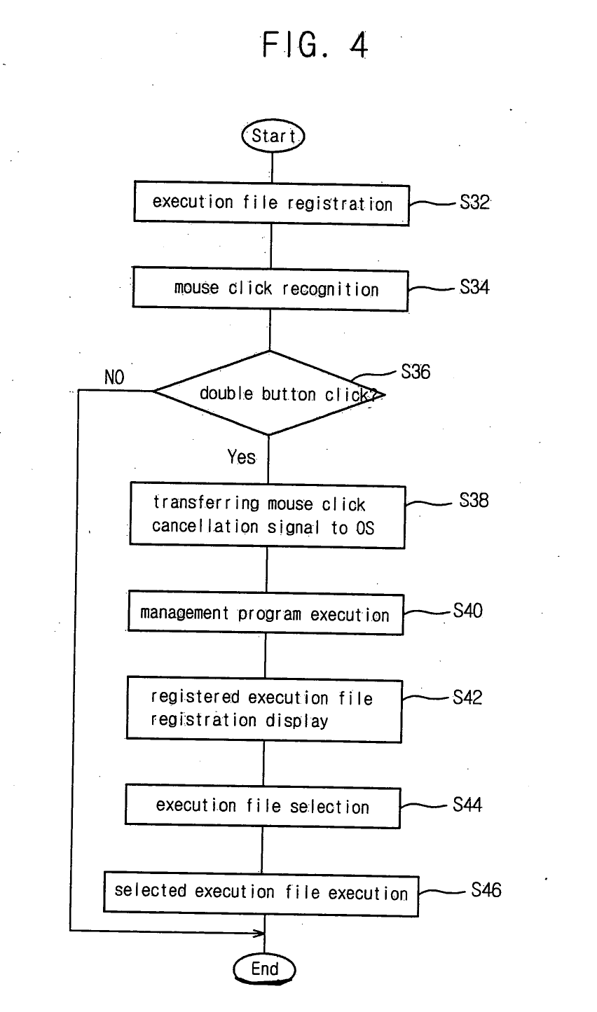

When the double buttons are simultaneously clicked, the program execution method will be described with reference to the flow chart of FIG. 4.

The information with respect to the execution file of the program executed when the double buttons of the mouse connected with the computer are simultaneously clicked is registered using the management program 10 of the execution file registration module 22 of the management program and is stored in the execution file DB 32 (S32). At this time, the registered file is programs such as Hangeul, word, photoshop, internet explorer, game, etc., individual file and homepage installed in computer, individual internet site URL such as URL of the internet site, RSS (Really Simple Syndication) page, news page, bulletin board, etc. and internet services.

In a state that the registration of the execution file is completed, when the left button or right button of the mouse connected with the computer is clicked, it is judged whether the clicked button corresponds to an individual click or the simultaneous double button click (S34). At this time, when the click is an individual click, the work is performed based on the state of a basic mouse of the computer OS 34.

As a result of the judgment, when the click corresponds to the simultaneous double button click (S36), a signal is outputted to the computer OS 34 for canceling the operation that the button of the mouse is clicked (S38). The computer OS cancels the click of the mouse based on the output signal, so that it is possible to prevent the display of the menu window displayed based on the click of the mouse.

When the simultaneous click of the double buttons is recognized, the management program 10 is executed on the upper most portion of the screen (S40), and the list with respect to the execution file registered in the execution file management window 12 is displayed (S42). At this time, in the case that the execution file registered in the management program is one, the registered execution file may be set and executed in a state that the management program is not executed.

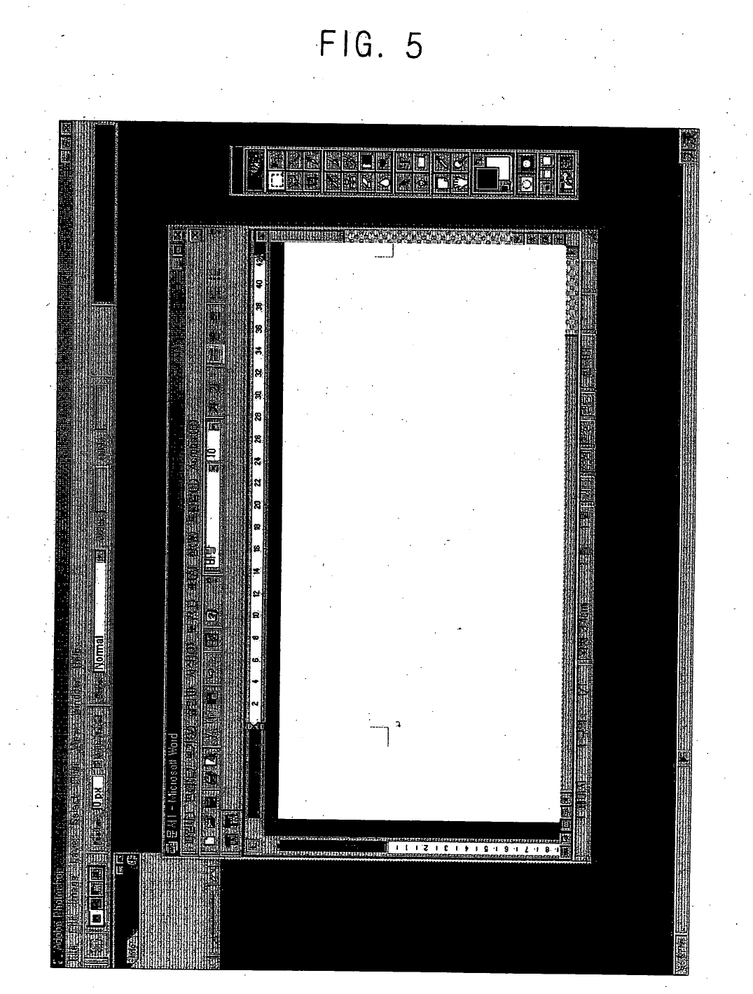

Thereafter, when the user checks the lists registered in the management program and selects the name of a desired program, the click signal with respect to a corresponding program is transferred to the computer OS 34, so that the program is executed (S46). For example, when the user clicks the double buttons of the mouse and selects the word program in the list of the management program while the user performs the photoshop program, as shown in FIG. 5, the word program is first displayed while the photoshop program is being used.

In the present invention, it is possible to easily execute a certain program such as MS office program while the user performs a certain program such as photoshop program, etc. or the user performs the internet program in such a manner that the mouse buttons are simultaneously clicked.

### INDUSTRIAL APPLICABILITY

As described above, in the present invention, it is possible to fast execute a certain program irrespective of the ongoing program in such a manner that the left and right buttons of the mouse are concurrently clicked.

In addition, in the case that the registered program is one, when the double button click of the mouse is checked, the management program is not displayed. Namely, a corresponding program is directly executed, so that the user can easily use the frequently used programs or the internet service.

The present invention is not limited to the above embodiment. As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A program execution system by a simultaneous click using double buttons of a mouse, comprising:
an execution file registration module in which information concerning an execution file of a program executed when the double buttons of a mouse are simultaneously clicked through a management program is registered, and the information is stored in an execution file DB and is managed;
a mouse click recognition module that recognizes a left button click, a right button click, and a simultaneous click of left and right buttons of a mouse connected with the computer;
an operating system (OS) management module that transfers a menu window cancellation signal to the computer OS so that a set menu window is not displayed when the button of a mouse of a computer is clicked at the time when the double buttons of the mouse of the computer are simultaneously clicked;
a registration file execution module that executes the selected program when a user selects a corresponding program from the lists of the execution files displayed together with the management program when the simultaneous click of the double buttons of the mouse is recognized by the mouse click recognition module; and
a control module that controls a data flow of each module.

2. The system of claim 1, wherein said management program includes:
an execution file management window in which the list of execution files is displayed and inputted;
an address input window that a user can directly input an address of the internet site; and
a display screen that receives an internet screen inputted through the address input window and displays the same.

3. The system of claim 1, wherein said execution file is one selected from programs such as Hangeul, word, photoshop, internet explorer, game, etc., individual file installed in computer, URL of the internet site, RSS (Really Simple Syndication page, news page, internet service, etc.

4. A program execution method using a simultaneous click of double buttons of a mouse, comprising:
a step in which when the double buttons of a mouse are clicked, an execution file of a program to be executed is registered;
a step in which when a button of a mouse is clicked, it is judged whether the click corresponds to a click using the double buttons of the mouse;
a step in which when it is confirmed that the double buttons are clicked, a cancellation signal is transferred to the computer operating system for canceling a display of the menu window set when the mouse of the computer clicks;
a step in which the list with respect to the registered program is displayed; and
a step in which the execution file of the program selected from the list is executed.

5. The method of claim 4, wherein in the case that the execution file registered in the management program is one, the registered execution file is directly executed when the simultaneous click of the double buttons of the mouse is confirmed.

6. The method of claim 4, wherein said execution file is one selected from programs such as Hangeul, word, photoshop, internet explorer, game, etc., individual file installed in computer, URL of the internet site, RSS (Really Simple Syndication page, news page, internet service, etc
